(19) United States
(12) Patent Application Publication
(10) Pub. No.: US 2020/0047549 A1
(43) Pub. Date: Feb. 13, 2020

(54) AUTOMOBILE WHEEL

(71) Applicant: Daniel Little, North Richland Hills, TX (US)

(72) Inventor: Daniel Little, North Richland Hills, TX (US)

(21) Appl. No.: 16/528,661

(22) Filed: Aug. 1, 2019

Related U.S. Application Data
(60) Provisional application No. 62/715,811, filed on Aug. 8, 2018.

(51) Int. Cl. B60B 21/10; B60B 7/06

(52) U.S. Cl. CPC B60B 21/104; B60B 7/063; B60B 21/102; B60B 2360/106; B60B 2360/104; B60B 2360/102; B60B 2900/711

(57) ABSTRACT

The invention relates to the improved design of a wheel with improved construction that is easier to assemble, more capable, stronger and thicker. The improved design of wheel is provided with an improved cylindrical rim in terms of design and material, and an improved wheel disk including plurality of apertures in extended space over the bolt pattern for air to pass through to avoid effect of windy conditions and a hub portion configured to he attached to an axle huh of a vehicle. Additionally, the hub portion of a wheel disk includes a 10 on 225 mm bolt pattern with 10 lug holes to get coupled with the vehicle hub using 225 mm threaded bolts that increases the weight capacity of the vehicle over 5, 6 or 8 lug vehicles. Said wheel is made of most preferably, but not limited to, the material such as aluminum by forging into single piece or 2 piece wheel making it light in weight with excellent durability. It is further designed according to double beadlock and runflat insertion capable when required to improve safety for the cases such as of tire deflation.

### CROSS REFERENCE TO RELATED APPLICATION

This application claims priority from U.S. Patent Application No. 62/715,811 filed on Aug. 8, 2018, which is incorporated by reference herein in its entirety.

### FIELD OF THE INVENTION

The present invention relates to the automobile wheels. More particularly, it is an improved design of wheel having improved rim and disk assembling structure for an automobile wheel that is stronger with high load capacity and that provides ease in assembling and better fitment in multiple vehicles with ease and perfection.

### BACKGROUND OF THE INVENTION

There are wide variety of wheels available in market made according to the load capacity of the vehicle. Conventionally, wheels are made by two main methods such as by forging the metal piece into the wheel shape and size or by casting the metal into the wheel mould to prepare a shape of a wheel. The main problem associated with the metal casting method is the defects it shows after casting such as gas porosity or air bubbles in metal after casting, shrinkage defects, mould material defect, pouring metal defect etc. Further, the bolt pattern, the disk and rim design also affects the strength, load capacity, rigidity and durability of the wheel. Conventional vehicles uses wheels with 5, 6 or 8 bolt pattern or we can say they uses 5, 6 or 8 bolt to couple the wheel with the vehicle hub and axle which can show deformity in the rim design such as deformity on the flanges that can make problem in balance of a heavy vehicles and sometime can cause an accident. Further, the strength of conventional wheel with spokes shows issues in heavy load condition that can causes damage to the wheel rim and coupling of the wheel with the vehicle.

To overcome such problems, there is a need for an improved design of a single piece or two piece forged wheel with an improved design of wheel disk having more huh connecting holes thus it can provide better fitment and more weight loading capacity as well as extra strength.

### SUMMARY AND OBJECT OF THE INVENTION

The principle object of the present invention is to overcome the aforementioned limitations and drawbacks related with prior art by providing improved design of wheel construction.

Another object of the present invention is to provide a very inexpensive and simple wheel to manufacture, whereby they may be turned out in large quantities by a very simple process of manufacture.

One more object of the present invention is to provide an improved design of a wheel that is stronger, thicker, easy to assemble and having more capacity over conventional wheel designs.

Another object of the present invention is to provide improved design of wheel having advance wheel size capable to fit in multiple vehicle safely with ease and perfection.

Yet another object of the present invention is to provide an improved design of wheel with a wheel disk having 10 of 225 mm bolt pattern for heavy duty vehicles.

One more object of the present invention is to provide an improved design of wheel that eliminates the need of centre spacers and adapters.

Yet another object of the present invention is to provide an improved design of wheel that is more preferably, but not limited to, the aluminum forged single piece or 2 piece wheel.

Yet another object of the present invention is to provide an improved design of wheel that is internal double beadlock and runflat capable to provide extra safety in case of deflation of tire.

### BRIEF DESCRIPTION OF THE DRAWING

FIG. 1 illustrates the cross-sectional view of wheel according to present invention where the disk is coupled with the rim.

FIGS. 2A and 2B illustrates Side and Front view respectively of main ring of three piece forged improved design of wheel rim of present invention.

FIGS. 3A and 3B illustrates Side and Front view respectively of centre plate of three piece forged improved design of wheel rim of present invention.

FIGS. 4A and 4B illustrates Side and Front view respectively of outer ring of three piece forged improved design of wheel rim of present invention.

### DETAILED DESCRIPTION OF THE INVENTION

The present invention overcomes the aforesaid drawbacks of the above and other objects, features and advantages of the present invention will now be described in greater detail. Also, the following description includes various specific details are to be regarded as merely exemplary. Accordingly, those of ordinary skill in the art will recognize that: without departing from the scope and spirit of the present disclosure various embodiments may be various changes and modifications described herein.

The present invention discloses an improved design of automobile wheel and the method of manufacturing thereof for a large vehicles. More particularly, it relates to the single piece, double or three piece aluminum forged vehicle wheel with a wheel size capable to fix in multiple heavy good vehicles or heavy passenger vehicles. Moreover, improved design of a wheel provide it an extra strength, durability, rigidity and more load bearing capacity. Hereinafter, we have described an exemplary embodiments of the two piece wheel comprising wheel rim and improved designed wheel disk and the three piece wheel comprising of main ring, centre plate and an outer ring, wherein all the pieces of the wheel is made of material such as, but not limited to aluminum or aluminum alloy that is light in weight and comparatively more rigid. Also it is to be understood that without departing from the scope, a single piece aluminum forged wheel of same design using same method can be prepared.

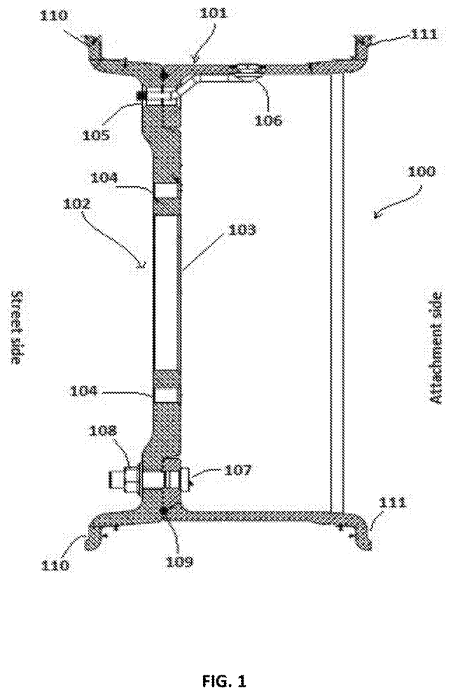

In FIG. 1 one exemplary embodiment of the two piece improved automobile wheel 100 according to present invention is illustrated, which is comprising of a Rim 101 and improved design of a wheel disk 102. At radially central portion of the wheel disk 102, the wheel hub hole 103 is located that is surrounded by the hub coupling portion (not shown) which consists of a plurality of hub bolt holes or lug holes 104. Said hub bolt holes may be equally spaced along a circumferential direction of a wheel. By passing the hub bolts extending from the hub through the hub bolt holes 104 and coupling hub nuts with bolts on receiving end, the wheel disk 102 and hence whole wheel gets fixed with the hub and axle of the vehicle. Further, the hub coupling portion of the wheel disk 102 comprises a 10 number of lug holes 104 to get coupled with the vehicle wheel thus making a 10 bolt pattern wheel that increases durability as well as weight bearing capability of the vehicle with increase in number of bolts. According to present exemplary embodiment of the invention the wheel disk 102 is connected with the rim 101 using a connection element such as specially designed threaded bolt 105 and nut 106 at one side and using a pair of conventional 225 mm nut & bolt (107,108) at opposite side of the wheel disk 102. The Connection member 107 are run from the side of the rim 101 and are received by the wheel disk unit 102 where it gets fixed using nut 108 making a joint 109.

The illustrated embodiment of wheel 100 further includes an outer flange or front flange 110 connected at the end of the wheel disk 102 and an inner flange or rear flange 111 connected at the ends of the rim 101 at the attachment side, moreover it includes an outer bead seat portion, an outer hump portion, an inner bead seat portion and an inner hump portion annularly formed over an entire territory of the street side of the wheel 100 or on the wheel disk 102 opposite surface of an outer flange 110 and inner flange 111 respectively according to present embodiment of the invention. A tire (not shown) is externally assembled to the outer peripheral of the rim 101 at a position between the outer flange 110 and inner flange 111 and the street side peripheral edge of a tire is fitted manually on the outer bead seat portion.

Furthermore, the wheel disk 102 comprises plurality of apertures in extended space over the hub coupling portion along a circumferential direction of a wheel for air to pass through to avoid effect of windy conditions. Moreover, the improved design of the wheel is capable of coupling double Beadlock and Runflat as well as the offset of the wheel eliminates the need of centre spacer and adapters.

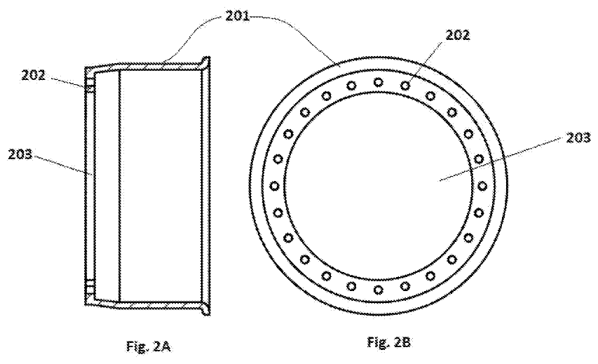

According to one another embodiment, an improved design of wheel of present invention can also be made in three piece forged wheel having same wheel rim design with extra strength, durability, rigidity and more load bearing capacity, where the three piece forged rim of present embodiment having three main parts to form whole wheel rim namely, a main ring, a centre plate and an outer ring. Now, referring to FIGS. 2A-2B, 3A-3B and 4A-4B which illustrates main ring, centre plate and outer ring of wheel rim respectively.

FIGS. 2A and 2B exemplarily illustrates the side and the front view of the main ring 201 of the three piece improved design of the forged rim of present invention which comprises plurality of equally spaced holes 202 in extended space over the aperture 203 along the circumferential direction of the main ring 201 that allows configuration of other two pieces of three piece wheel rim to form complete improved designed wheel rim. While the aperture 203 allows conform fitting of other two pieces to form improved design of wheel rim of present invention.

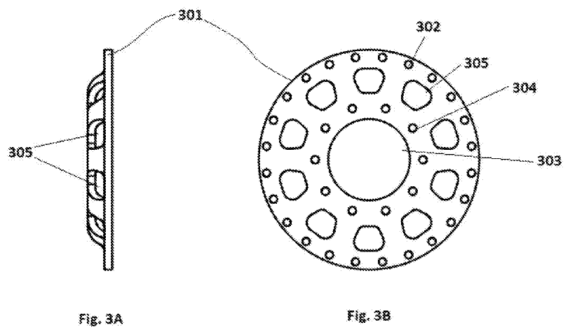

Now, FIGS. 3A and 3B illustrates side and front views respectively of centre plate 301 of the improved designed three piece forged wheel rim of present invention. According to present exemplary embodiment, the centre plate 301 comprises a plurality of holes 302, a central hub hole 303, a plurality of lug holes 304 and a plurality of apertures 305 within the space of the centre plate 301 along the circumferential direction of the centre plate 301. The plurality of holes 302 of the centre plate 301 allows attachment of centre plate 301 within the main ring 201 of FIG. 1 using conventional nut and bolt to form a complete three piece wheel rim. The hub hole 303 located at radially central portion of the centre plate 301 and plurality of lug holes 304 surrounded around hub hole 303 in extending space within the centre plate 301 allows fixing of wheel rim with the hub and axle of the vehicle by configuring hub of the vehicle within the hub hole 303 of the wheel rim, passing the extended hub bolts of vehicle hub through the lug holes 304 and coupling the hub nuts with bolts on receiving end. The number of lug holes 304 is preferably 10, hence the wheel rim gets attached with the vehicle using 10 conventional 225 mm bolts. The plurality of apertures 305 within the centre plate 301 is configured for air to pass through to avoid effect of windy conditions.

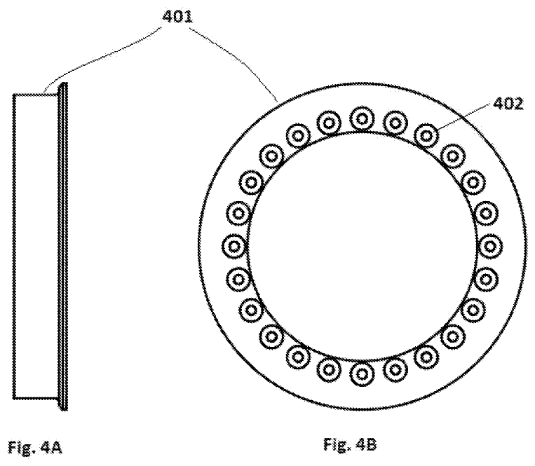

Referring to FIGS. 4A and 4B which exemplarily illustrates side and front views of outer ring 401 of wheel rim respectively. According to present embodiment, the outer ring 401 comprises a plurality of holes 402 that allows the outer ring to be fixed over the main ring and centre plate of the three piece embodiment of wheel rim of present invention. The outer ring further comprises a flange which after attachment of the outer ring with the other two pieces of the wheel rim behaves as the outer flange of the wheel rim.

The foregoing disclosure is not intended to limit the present disclosure to the precise form or particular field of use disclosed. As such, it is contemplated that various alternate embodiments and/or modifications to the present disclosure, whether explicitly described or implied herein, are possible in light of the disclosure. Having thus described embodiments of the present disclosure, person of ordinary skill in the art will recognize that changes may be made in the form and details without departing from the scope of the present disclosure is limited only by the claims.

1. An improve design of single or double piece forged automobile wheel for heavy vehicles comprises;
a cylindrical forged rim with improved design of flange, bead seat and an annularly formed hump portion;
a spoke less metal forged wheel disk with centre hub hole, a plurality of hub bolt holes and a plurality of rim and disk coupling holes (in case of double piece design), and
an attachment members connecting the wheel rim with the disk and a wheel with a vehicle hub.

2. The automobile wheel of claim 1, wherein the metal is selected from the group consisting of forged aluminum, aluminum alloy, magnesium alloy, carbon steel, forged steel.

3. The automobile wheel of claim 1, wherein the disk comprises 10 equidistance disk coupling holes to couple the wheel with axle and hub of a vehicle making a 10 bolt pattern.

4. The automobile wheel of claim 1, wherein the disk further comprises a plurality of apertures in extended space over the bolt pattern for air to pass through and to avoid effect of windy conditions.

5. The automobile wheel of claim 1, wherein the wheel is internal double bead lock and runflat capable.
